(19) United States
(12) Patent Application Publication
(10) Pub. No.: US 2024/0193630 A1
(43) Pub. Date: Jun. 13, 2024

(54) Group-Based Electric Vehicle Charging Optimization Systems and Methods

(71) Applicant: Rainforest Automation, Inc., Vancouver (CA)

(72) Inventors: Richard Thomas Jones, Coquitlam (CA); Christopher Stanley James Tumpach, Vancouver (CA)

(21) Appl. No.: 18/530,092

(22) Filed: Dec. 5, 2023

Related U.S. Application Data
(60) Provisional application No. 63/430,992, filed on Dec. 7, 2022.

(51) Int. Cl. G06Q 30/0202; B60L 53/62; B60L 53/63; B60L 53/64; G06Q 30/0201; G06Q 50/06

(52) U.S. Cl. CPC G06Q 30/0202; B60L 53/62; B60L 53/63; B60L 53/64; G06Q 30/0206; G06Q 50/06; B60L 2250/00

(57) ABSTRACT

Active demand management systems and methods are disclosed herein. An example method includes determining one or more conditions necessary to compute a rule set, determining a current state of one or more devices, receiving user inputs and overrides, if any, via the one or more devices, determining both a forecasted demand and a demand threshold, based on the rule set, the current state of each of the one or more devices, and the user inputs and overrides, when the forecasted demand is greater than the demand threshold, generating a plan to power off the one or more networked devices, one by one, in an order from the least important device to the most important device, until the forecasted demand no longer exceeds the demand threshold; and delivering energy-related device commands for the one or more devices, based on the generated plan.

### CROSS-REFERENCE TO RELATED APPLICATIONS

This application claims the benefit and priority of U.S. Provisional Application Ser. No. 63/430,992, filed on Dec. 7, 2022, which is hereby incorporated by reference herein, including all referenced and appendices, as if fully set forth herein, for all purposes.

### FIELD

This disclosure pertains to active demand management, including the selective charging of systems such as vehicles, in an intelligent manner relative to the infrastructure providing power to the same.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for providing active demand management. The method also includes determining one or more conditions necessary to compute a rule set; determining a current state of one or more devices; receiving user inputs and overrides, if any, via the one or more devices; determining both a forecasted demand and a demand threshold, based on the rule set, the current state of each of the one or more devices, and the user inputs and overrides; when the forecasted demand is greater than the demand threshold, generating a plan to power off the one or more networked devices, one by one, in an order from the least important device to the most important device, until the forecasted demand no longer exceeds the demand threshold; and delivering energy-related device commands for the one or more devices, based on the generated plan. Other embodiments of this aspect include corresponding computer systems, apparatus, and computer programs recorded on one or more computer storage devices, each configured to perform the actions of the methods.

Implementations may include one or more of the following features. The method where the one or more devices includes one or more electrical vehicles. The method may include calculating the energy delivered to the one or more electrical vehicles. The rule set is based on historical energy usage data, time-of-use tariffs, or grid demand patterns. The user inputs and overrides may include preferred device operational hours or specific times when a device must remain operational. The energy delivered to the one or more electrical vehicles is prioritized based on user-defined vehicle usage schedules or a battery state of charge. The demand threshold is adjustable and can be set either manually by a user or automatically based on historical grid demand data. Determining an operational status of a device includes checking if the device is in standby, active, or sleep mode. A calculation of energy delivered considers both efficiency of an electrical vehicle's charging system and the state of a vehicle's battery. The generated plan to power off devices also considers potential energy-saving modes for devices before completely turning them off. The method may include sending notifications to users about potential device power-offs and giving an option for manual overrides. Implementations of the described techniques may include hardware, a method or process, or computer software on a computer-accessible medium.

One general aspect includes a method for enhanced EV energy management. The method also includes collecting high-frequency Eagle data (high-frequency smart meter data (via a home energy monitoring system or similar). It will be understood that EAGLE is a brand name for a Rainforest gateway that connects with utility smart meters to obtain real-time energy data (demand in kW and consumption in kWh) from a building (home/commercial/industrial). Such real-time energy data can be measured by a metering device such as an electric utility's smart meter. The smart meter's measured data can be collected from the utility's network for historical purposes by the utility's own network, or by another device (such as Rainforest's EAGLE gateway) which is real-time data. The method also includes integrating advanced metering infrastructure (AMI) data, transformer details, and external variables such as weather; utilizing the collected data to group multiple electric vehicles under single or multiple meters, ensuring cumulative charging does not exceed set limits; forecasting and managing loads based on integrated data, ensuring adherence to grid constraints and rated capacities; accessing real-time dynamic pricing data through third-party service integration; and integrating real-time data from utility or independent system operators (ISO) to optimize load forecasting and comprehend grid limitations. Other embodiments of this aspect include corresponding computer systems, apparatus, and computer programs recorded on one or more computer storage devices, each configured to perform the actions of the methods.

Implementations may include one or more of the following features. The method may include the step of correlating energy consumption patterns of electric vehicles over time to create distinct charging profiles for each of the electric vehicles. The integration of data includes a specific module for weather forecasts that synergizes with the load forecasting mechanism. The method may include sourcing dynamic pricing updates that include real-time nature of the pricing data. The load forecasting module consolidates data from weather predictions, AMI meter readings, and transformer metadata to deduce optimal charging strategies for grouped electric vehicles. The method may include continuously evaluating grid limitations and juxtaposing this data with the electric vehicles charging needs to maintain grid stability. Implementations of the described techniques may include hardware, a method or process, or computer software on a computer-accessible medium.

One general aspect includes a system for providing active demand management. The system also includes a processor; and a memory coupled to the processor, the memory for storing instructions executable by the processor to perform a method may include: determining one or more conditions necessary to compute a rule set; determining a current state of one or more devices; receiving user inputs and overrides, if any, via the one or more devices; when one or more devices may include one or more electrical vehicles (EVs), calculating energy delivered to the one or more EVs; determining both a forecasted demand and a demand threshold, based on the rule set, the current state of each of the one or more devices, the user inputs and overrides, and the energy already delivered to the one or more EVs, when the forecasted demand is greater than the demand threshold, generating a plan to power off the one or more networked devices one by one, in an order from least important device to most important device, until the forecasted demand no longer exceeds the demand threshold; and delivering energy-related device commands for the one or more devices, based on the generated plan. Other embodiments of this aspect include corresponding computer systems, apparatus, and computer programs recorded on one or more computer storage devices, each configured to perform the actions of the methods.

### BRIEF DESCRIPTION OF THE DRAWINGS

Exemplary embodiments are illustrated by way of example and not limited by the figures of the accompanying drawings, in which references indicate similar elements.

FIG. 1 is an example architectural environment where aspects of the present disclosure can be practiced.

FIGS. 2 and 3 collectively illustrate an example modeling of a method of the present disclosure.

FIG. 4 is another example architectural environment where aspects of the present disclosure can be practiced.

FIG. 5 is a flowchart of an example method of the present disclosure.

FIG. 6 is a flowchart of an example method of the present disclosure.

FIG. 7 is a schematic diagram of an example computer system that can be used to implement embodiments of the present disclosure.

### DETAILED DESCRIPTION OF EXAMPLE EMBODIMENTS

### Overview

The present disclosure relates to the dynamic management of electric vehicle (EV) charging in local grids, specifically at the transformer or feeder levels. Although methods exist for fleet-level group electric vehicle (EV) management, as well as for residential-level single-home EV charging management, a mechanism of control and transparency of EV and EV-related grid resources that satisfy both user charge requirements, as well as utility group demand profile requirements, is not currently available.

Despite the relatively low penetration of electric vehicles in North America at present, infrastructure limitations are already becoming apparent. Breakers are under-sized and homes are under-serviced for the loads associated with Level 2 home charging, transformers are under-rated for large combined loads as neighborhoods increasingly adopt EVs, and so forth. Supply chain constraints are also resulting in long turnaround times for infrastructure upgrades, leading to customer frustration and/or utilities offloading costs onto their customers. Part of the issue is the behavioral regularity associated with EV charging, which typically occurs in the early evening when demand is already highest.

On a larger scale, this issue adds to the so-called “duck-curve” problem, which is the undesirable aggregate load curve associated with renewables and low usage during the day, and high usage during the evening. These problems make generation capacity increasingly difficult to anticipate and deliver for grid operators.

A common solution for utilities is to incentivize good charging habits using tariff schedules. Typically, these tariffs are static pricing schemes for different times of the day and/or days of the week. Implementing or modifying these static tariff schedules has major bureaucratic barriers, leading to a lack of dynamic control of grid resources. There are also dynamic pricing schemes that allow a utility to set an electricity price relative to current grid demand, which would in principle allow a level of dynamic control on grid resources. However, these are far less popular with utilities and require even more bureaucratic effort to initiate. Furthermore, the extent of dynamic control or resources with dynamic pricing is limited to the extent to which a utility's customers are made aware of the current (and forecasted) energy price.

Another solution made possible with the increasing prevalence of smart chargers is the remote control and/or scheduling of charging sessions. When left to the control of individual EV customers, however, they would typically only follow their respective electricity rate schedules, which again can lead to a lack of dynamic control for utilities. A recent study on smart thermostats showed that uncoordinated control algorithms can lead to significant load synchronization and unintended demand peaks during winter months, despite lowering the cost of energy for individual homes.

Active demand management (ADM) systems and methods are described herein, which help to manage “behind the meter” energy resources in structures, such as homes, commercial buildings, condominiums, and the like. Demand management systems can be used to avoid excess demand relative to residential or commercial pricing motivations, demand response events as specified by a utility provider, and/or to manage resources behind an over-subscribed electrical panel such that electrical codes are satisfied. With increasing penetration of large loads such as electric vehicle chargers, management of these and other connected devices has become increasingly important. Traditionally, energy resources are managed by making a prediction about energy resources shortly and addressing energy issues at a later time.

However, with the advent of intermittent and distributed energy resources such as wind and solar energy, it has become increasingly difficult to make predictions about energy resources the next day or in the short-term future. The compounded problem of unpredictable energy resources, coupled with increased energy needs from such devices such as EVs, pose many challenges. The undesirable alternative at this time is to upgrade all the infrastructure which is uneconomical and not practicable.

Thus, the objectives of an active demand management system are to be flexible, dynamically predictive, and also be both adaptive and reactive to a multitude of variables or as different inputs appear. Also, the exemplary embodiments of the ADM system described herein are designed to manage a plurality of different energy resources, such as electrical vehicles (EVs), water tanks, smart thermostats, and the like. The exemplary ADM system also addresses infrastructure issues where the existing infrastructure, grids, and utilities cannot maintain or keep up with the energy demands of the energy resources of the people residing in a given neighborhood or building. The adaptive ADM system dynamically addresses the energy demands, without requiring a teardown, rebuild, or an expensive and time-consuming hardware upgrade of the existing infrastructure. Thus, the exemplary ADM system is a less costly and more efficient software-based solution to the increasing energy demands of a given neighborhood, household, or structure.

### Example Embodiments

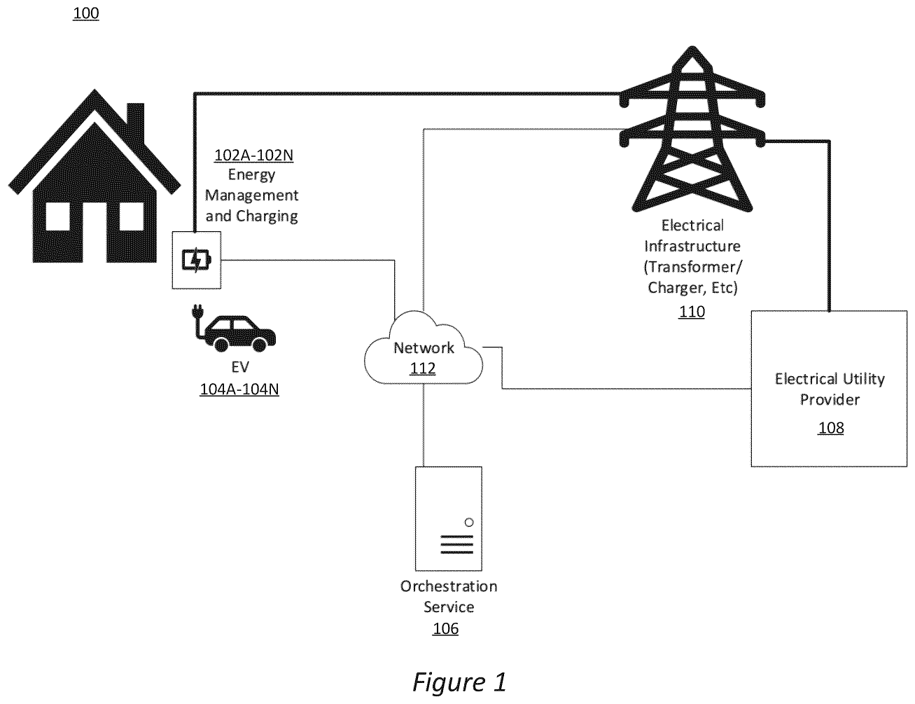

FIG. 1 is a schematic view of an example architecture of the present disclosure. The proposed EV charging management system 100 is comprised of several key components, each playing a role in optimizing the charging process and ensuring efficient grid operation. The example architecture includes smart EV chargers 102A-N, electric vehicles 104A-N, a central system, or orchestration service 106, a utility provider 108, utility infrastructure 110, and a network 112. The network 112 can provide a means for allowing communications between components of the system 100 and can include any short or long-range wired or wireless communications.

In general, the system can accommodate any number of smart EV chargers 102A-N that communicate via OCPP 1.6J or higher. These chargers are equipped with communication capabilities, allowing them to receive and execute charge commands as part of the overall optimization process. Any number of EVs can be integrated into the system, provided they are capable of receiving remote charge commands. This feature allows the orchestration service 106 to control and manage the charging sessions of these vehicles efficiently.

A central component, the orchestration service 106, is responsible for sending relevant charge commands to both smart EV chargers and EVs. This central system acts as the orchestrator, coordinating the charging activities based on user preferences, grid conditions, and other factors.

For solar customers, the system offers the option of integrating a home energy monitoring system such as Eagle or AMI data (as non-limiting examples). This additional data source helps in optimizing charging by taking into account household energy consumption and excess solar generation. Solar customers also have the option to incorporate a method for predicting excess solar generation. This prediction allows the system to make informed decisions about whether to use excess solar power for EV charging or export it to the grid.

The orchestration service 106 includes a method to express or infer user-specific charge requirements. This can be in the form of a mobile app with a scheduling feature, enabling users to set their desired charging parameters, including energy levels and deadlines. To optimize group charging profiles effectively, the system provides a method to determine or infer utility-defined Ideal Group Profile (IGP) properties. This information helps align the charging behavior of multiple EVs with the utility's goals and grid conditions.

Understanding the pricing schedule of individual users is crucial for cost optimization. The system ensures access to the pricing schedules of users, allowing it to make decisions that minimize charging costs based on the rates applicable during different time intervals. The orchestration service 106 includes an energy optimization algorithm that operates at a granular level, often in 15-minute intervals. This algorithm balances multiple objectives, including satisfying user charge requirements, minimizing charging costs and aligning the combined group profile (CGP) with the utility's IGP. It adjusts these considerations with adjustable weights, allowing flexibility to meet varying utility requirements.

The orchestration service 106 continuously monitors for the initiation of new charging sessions and iteratively optimizes the charging process for all active sessions as they progress. This dynamic approach ensures that EV charging remains responsive to user needs, grid conditions, and pricing fluctuations, ultimately leading to more efficient and coordinated charging practices.

The following will disclose the parameters and considerations involved in defining a charge session request within their proposed electric vehicle (EV) charging management system. Users are given the flexibility to express their EV charging requirements explicitly or have them inferred by the system. When explicit, users can set up charging schedules through app interfaces, specifying details such as charging to a certain percentage of battery capacity on specific days and times. Alternatively, the system allows for interactive notifications upon vehicle connection, where users can communicate their immediate range needs, for instance, ensuring they have a certain distance available for a specific time.

When charge requirements are inferred, the system takes into account a conservative estimate of the required range and historical disconnection times, which indicate when the user typically needs their vehicle to be charged and ready. Moreover, the system recognizes that users may have varying levels of range anxiety and may prefer to enforce a deadline for receiving a minimum charge, which could be critical, such as having enough charge to reach a nearby hospital in case of emergencies.

A charge session request is defined by four key properties: (1) total amount of energy requested, which relates to the user's current and desired state of charge or range; (2) deadline for the delivery of the requested energy; (3) (Optional) Minimal amount of energy requested, representing an emergency charge; and (4) (Optional) deadline for the delivery of the minimal energy.

The system also considers various user-specific properties, such as location, pricing plan, voltage supply for the charger (known from the charger), amperage states available for control (some chargers offer multiple amperage levels, while others may have binary on/off control), and the maximum power acceptance of the EV (known from the EV model).

For solar customers, the system incorporates historical and/or ongoing household consumption data to account for the availability of excess solar generation. This data allows the system to make optimal decisions regarding whether to utilize excess solar power for EV charging or export it to the grid.

Utility-related information is equally crucial, including the identification of users/chargers within a specific group. This grouping can be provided by the utility or inferred based on grid topology or spatial proximity. The concept of the Ideal Group Profile (IGP) is introduced to represent the utility's desired demand for the group. It is expressed as a relative desired demand value between 0 and 10, where 0 indicates no charging should occur, and 10 signifies that all users should charge immediately if connected. The IGP is a crucial factor for coordinating group charging behaviors.

The system continually monitors the chargers within a group and generates a session energy schedule (SES). The SES is presented as a matrix with dimensions (n×T), where n represents the number of currently active charge sessions, and T corresponds to the number of time slots needed for the longest active charge session. This dynamic approach ensures that the system can effectively manage and optimize charging sessions for multiple users within a group while considering their individual needs and preferences.

The constraints placed on valid solutions to the SES matrix at a given time t are as follows: For each charger I:

SES(i,t)∈E_{s,i} Equation 1

The notation provided above refers to specific elements within the SES matrix. Each element pertains to a certain charger, denoted by (i), and represents an energy delivered by the charger over a particular time interval (t). The set (E_{s,i}) outlines the acceptable states or configurations applicable to the charger (i). That is, in Equation 1 above energy is delivered in increments consistent with the voltage and amperage states of the charger, as well as the maximum power acceptance of the EV.

Equation 1 elaborates on constraints for energy delivery using these chargers. Specifically, when energy is being delivered to an electric vehicle (EV) from any charger it must adhere to certain guidelines. The energy increments provided to the EV must be compatible with the charger's voltage states, its amperage states, and crucially, they should not exceed the maximum power acceptance capacity of the EV. This ensures not only the efficient operation of the charger but also the safety and longevity of the EV's battery.

In a related equation:

SES(i,t)=0,∀t>t_{c,i} Equation 2

The expression defines specific conditions for the elements within the SES matrix. Here, each element pertains to a certain session, represented by (i), and a particular time slot or instance, denoted by (t). Equation 2 clarifies how the SES matrix should be structured. In essence, for the matrix to be of dimensions [n×T], any sessions that conclude at their designated completion time, t_{c,i}, must be followed by zeros. This means that for a given session (i), any time slot (t) that exceeds the session's completion time t_{c,i}, should have a value of zero in the matrix. This “zero padding” ensures that the matrix maintains its desired dimensions, providing consistency and uniformity in representing session data across various time frames.

Equation 3 governs conditions in relation to the energy delivered during various sessions:

$${\sum }_{t = 1}^{{t}_{c , i}} SES ( i , t ) \approx {E}_{tot , i} \qquad Equation 3$$

Each element in the sum pertains to a session, denoted by (i), and sums over different time slots or intervals, represented by (t), until the desired completion time t_{c}. Equation 3 provides insights into the energy requirements and delivery during these sessions. Essentially, by the time a session reaches its intended completion time t_{c}, the cumulative energy delivered across all prior intervals—represented by the sum—should be roughly equivalent to E_{tot,i}, the total requested energy for that session. This stipulation ensures that the energy requirements of a session are met by its designated end time, facilitating efficient energy management and delivery.

Equation 4 lays out specific conditions concerning the energy provision across sessions:

$${\sum }_{t = 1}^{{t}_{m , i}} SES ( i , t ) \geq {E}_{min , i} \qquad Equation 4$$

In this notation, each term of the summation is related to a particular session. This session is then assessed over various time points or slots, leading up to a moment denoted as t_{m,i} which signifies the minimum charge deadline for charger (i).

Equation 4 outlines an essential directive for energy distribution over these sessions. It conveys that, when a session progresses to its minimum charge deadline t_{m,i} the total energy supplied across all preceding time intervals—as captured by the summation—should at the very least match E_{min,i} the desired minimum energy charge for that session. This requirement guarantees that every session achieves its stipulated minimum energy charge by its defined deadline, thus ensuring that basic energy needs are consistently met within the given time constraints.

Equation 5 serves as an insightful measure to evaluate the accuracy and efficacy of the proposed energy scheduling system, specifically known as SES. Breaking down the components of the equation provides a more detailed understanding of its purpose and functionality.

$${L}_{R} = \frac{δ ( IGP , {\sum }_{i = 1}^{n} SES ( i , t ) )}{{δ}_{max}} \qquad Equation 5$$

The reconstruction loss term L_{R} represents the normalized measure of how accurately the SES approximates the Ideal Grid Profile (IGP) in terms of energy delivery to electric vehicles (EVs) over a set time frame. The error metric, δ, could take the form of, for example, the Mean Absolute Error (MAE), and evaluates the discrepancy between two data sets. Here, it is used to measure the difference between the IGP and the aggregated energy provided by the SES, as represented by the summation over all active charging sessions.

The δₘₐₓ term represents the most significant possible error. This occurs when no EVs are charged, essentially resulting in the highest potential deviation from the IGP. By dividing δ( . . . ) by δₘₐₓ the error is normalized to fall within the range [0,1], making it easier to interpret and compare against other metrics.

In essence, Equation 5, termed as the Reconstruction Loss Term, quantifies the effectiveness of the SES. By comparing its performance against an ideal grid profile (IGP) and then normalizing this comparison to the worst possible outcome, it allows for an objective assessment of the system's efficiency and reliability. The closer L_{R} is to 0, the better the SES is at matching the IGP; conversely, values approaching 1 indicate substantial deviations from the ideal.

Equation 6 provides a standardized measure of the economic impact associated with the energy scheduling system, denoted here as SES. In more detail, the Cost Term L_{C} provides a normalized metric that evaluates the economic cost incurred during energy delivery to electric vehicles (EVs) under the SES relative to the maximum possible cost.

$${L}_{C} = \frac{1}{n} {\sum }_{i = 1}^{n} ( \frac{{\sum }_{t = 1}^{T} SES ( i , t ) ⊙ C ( i , t )}{{C}_{max , i}} ) \qquad Equation 6$$

The Cumulative Session Cost is an inner summation and represents the accumulated cost for each individual user, derived from multiplying the energy scheduled in the SES with the cost matrix, denoted by C(i,t). The Worst Session Cost is a hypothetical worst-case scenario, where the user is charged using the maximum amperage state at the most expensive per kilowatt-hour rate over the required number of 15-minute intervals. The division by C_{max,i} serves to normalize the cumulative session cost, making it more interpretable as it bounds the value between 0 (no cost) and 1 (maximum possible cost).

The Average Across All Users, an external summation, paired with the frac₁ₙ factor, averages the normalized costs across all users, providing an overall average cost metric for the system. Of note, the ⊙ indicates the element-wise or Hadamard product.

In summary, the Cost Term, represented by the equation, quantitatively illustrates the economic efficacy of the SES. By comparing the actual cost of energy delivery against a theoretical maximum cost, it offers an objective assessment of the system's financial prudence. A value closer to 0 indicates a highly economical system, while values nearing 1 suggest more expensive energy delivery relative to the worst-case scenario.

Note that for solar customers, we augment the SES matrix by subtracting out the forecasted net household consumption when negative (i.e., when exporting to the grid). This way, the solver is motivated to use the excess solar amount for EV charging, which is preferable financially to exporting to the grid at a reduced buy-back price.

For some customers, pricing plans may also include premiums on household peak demand—premiums that can be a substantial portion of total energy cost. For such customers, the previous objectives will not in general avoid these charges, and so for the subset n_D of customers with such pricing plans, a demand term as shown below is added. This term takes the forecasted (non-EV) demand and tries to minimize the largest sum with the proposed EV charging sessions. In other words, we try to—on average—avoid charging for these customers where their forecasted household demand is already high.

$${L}_{C} = \frac{1}{{n}_{D}} {\sum }_{i = 1}^{{n}_{D}} ( {max}_{t} ( SES ( i , t ) \cdot {V}_{i} + \hat{D} ( i , t ) ) ) \qquad Equation 7$$

Equation 7 encapsulates the demand-centric considerations of the energy scheduling system (SES) for a specific subset of users. The Demand Term L_{D} represents a weighted metric that evaluates the demand impact associated with electric vehicle (EV) charging for users who might face premium charges based on their peak household demand. This term aims to minimize the maximum demand peaks by smartly scheduling the EV charging sessions.

The Peak Demand Calculation, the inner operation, calculates the total demand peak for a user (i) by summing the demand scheduled for EV charging (SES multiplied by the corresponding charger voltage) with their forecasted non-EV demand (\hat{D}(i,t)). The use of the max function identifies the highest demand spike throughout the entire session.

A Forecasted Non-EV Demand represents the predicted maximum household demand, excluding the EV charging, for a specific user over a given time interval (t). An Average Peak Demand Across Subset is the external summation, along with the factor 1/n_{D} averages the maximum demand peaks for users who have pricing plans sensitive to peak demands. This gives a collective assessment of how well the SES is mitigating peak demand charges for this subset of users.

In essence, the Demand Term, encapsulated by the equation, provides a quantitative measure of the system's performance in managing demand peaks for users sensitive to peak demand charges. By focusing on reducing the combined energy demand spikes, the SES endeavors to protect these users from incurring additional costs associated with high demand peaks. The closer the value of L_{D} is to the baseline forecasted demand, the better the system is performing in managing peak demand for this subset of customers.

In Equation 8, the objective function is the weighted sum of these loss terms:

L=L_{R}+λ_{C}L_{C}+λ_{D}L_{D} Equation 8

The given Equation 8 represents the cumulative objective function, which is formed by summing up three distinct loss terms each associated with specific considerations in the energy scheduling system (SES) for electric vehicle (EV) charging. Here's a detailed breakdown:

The Reconstruction Loss L_{R} captures the deviation between the controlled group profile and the intended grid profile (IGP). In essence, it gauges how accurately the SES can match the scheduled energy delivery to the desired grid energy profile.

The Cost Loss L_{C} addresses the monetary implications of the energy scheduling. It measures how cost-effective the energy delivery schedule is in comparison to the most expensive charging scenario. The goal here is to minimize the monetary expenditure associated with charging.

The Demand Loss L_{D} is concerned with the demand-driven costs or premiums associated with peak energy demand. By focusing on this loss, the system tries to avoid charging sessions during periods of high household energy demand, especially for users whose pricing plans are sensitive to peak demand.

The λ Weighting Factors C and D allow for tunable prioritization of the cost and demand loss terms, respectively. Depending on their values, more emphasis can be placed on cost savings, demand considerations, or a balanced approach.

In summary, the combined objective function L encapsulates the primary goals of the SES: aligning with the intended grid profile, optimizing cost, and managing peak demand. The system will aim to minimize this function to achieve an energy scheduling that balances these objectives in the most efficient manner. By adjusting the weighting factors, stakeholders can fine-tune the importance of cost and demand considerations to best suit their requirements or the specific constraints of the grid.

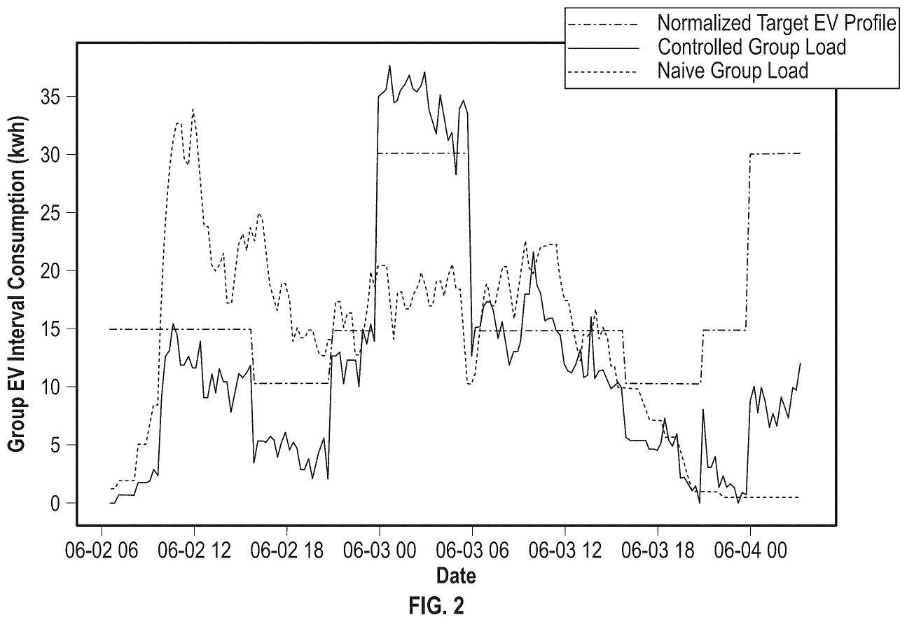

FIGS. 2 and 3 collectively illustrate the empirical modeling of EV management according to the present disclosure. To simulate a set of users, the time of connection as Gaussian with a mean of 4:00 pm and a standard deviation of 4 hours were modeled (i.e., 86% of sessions connect between the hours of 12:00 pm and 8:00 pm). A random selection from 1 to 5 non-zero amperage states from the set [6, 8, 12, 16, 18, 20, 24, 32]. One of four regionally relevant EV price plans is selected at random. A random session energy to be delivered between 4 and 40 kWh is selected, as well as a charge deadline randomly from the minimum possible deadline to a maximum of 30 hours ahead. We select with probability 0.4 whether the user requires an emergency minimum charge, and if so, a randomly selected minimum energy from 1 kWh up to the session energy above is delivered by a random deadline chosen between the minimum possible deadline up to the deadline selected for the overall session energy request. Finally, we select with probability 0.2 whether the user has available solar, and provide a randomly sampled snippet of real household interval consumption consistent with the selected session time and duration, along with consistent historical consumption and weather data with which initial forecasts are made. For some users, the battery state of charge may not be available, and they may not respond to requests to enter their starting state of charge when the vehicle is connected. For this subset of users (which we take at random with probability 0.1), we randomly select a modifier on the energy requested for the session, such that the session is optimized with respect to a larger total energy to be delivered than is needed for the vehicle. These users are expected to typically have sub-optimal session cost.

Without any intervention, a reasonable simulation of naive sessions satisfying users' total charge requirements involves a large peak in interval consumption that aligns poorly with the IGP. The controlled load still satisfies all user's charge requirements by the requested time, along with any minimum charge requirements, but much more closely approaches the IGP provided by the utility. Important to note is that the larger a group becomes, the more likely it is that flexible users can compensate for inflexible users with respect to the IGP.

When analyzing, the session cost accrued by each user in the controlled and naive case, we see that not only can the system deliver all charge requirements while approaching the IGP, but it can save customers significant amounts of money relative to naively charging.

Two comparisons are made below for the case of N=50 (i.e., 50 users with active sessions between the hours of 6:00 am on June 2, to around 2:00 am on June 5 as below). The first is a comparison of the desired group profile relative to the controlled and “naive” group profile, where “naive” is meant to mean what charging would have looked like in the absence of any control (i.e., each user charges at the maximum possible speed consistent with their charger/vehicle from the time of connection until delivery of the requested session energy).

The second comparison is the energy cost for each user, shown below relative to the “naive” cost, again indicating the cost associated with charging at the maximum possible speed consistent with a user's charger/vehicle from the time of connection until delivery of the requested session energy. Also shown is the “optimal” cost, which indicates the cost associated with delivering the requested session energy at the maximum possible speed for the cheapest possible times (for the given user's price plan) from the time of connection to the given user's charge deadline. Note that when the optimal cost is near or equal to the naive cost, this indicates a requested session near or equal to the naive session (i.e., the user wanted their charge as fast as possible).

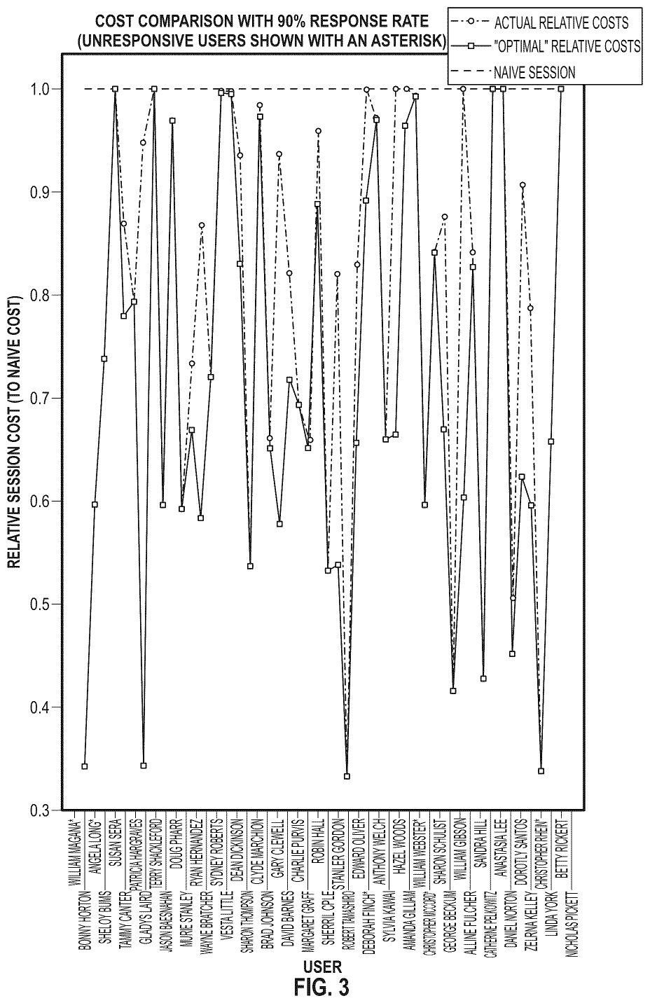

FIG. 4 is a schematic that illustrates a system with advancements in EV energy management. The system, such as the orchestration service of FIG. 1, can group multiple electric vehicles under one meter, ensuring they don't collectively exceed the set charging limits. Another feature is the utilization of high-frequency Eagle data (utility provider), allowing the system to predict and manage loads, ensuring no breach of rated capacity and grid constraints. There's also the integration of Advanced Metering Infrastructure (AMI) data, transformer details, and other variables like weather. This data fusion enables the accurate grouping of meters and forecasts their combined loads. The system also embraces real-time dynamic pricing through third-party service integration. Furthermore, the platform has been enhanced to efficiently integrate real-time data from utility or Independent System Operators (ISO), resulting in improved load forecasting and a detailed understanding of grid constraints.

The architecture includes transformers, meters, and power consumption profiles. A transformer labeled “Transformer A” possesses a 35 kVA rating. Two distinct meters, “Meter A” and “Meter B”, are depicted, both offering a 100-amp service. Meter A serves two electric vehicles, whereas Meter B caters to one. Each vehicle has a unique power graph detailing its energy consumption patterns over time, offering insights into their respective charging behaviors.

The system intricately interlinks various data sources and algorithms. There's a distinct module for weather forecasts that integrates with the load forecasting mechanism. Another notable feature is the dynamic pricing updates sourced from the example “Temix System,” emphasizing the real-time nature of pricing data. Other similar data sources can be used. To be sure, there are mentions of certain specific data types or systems herein, and it will be understood that these are not intended to be limiting.

The load forecasting module collates data from weather predictions, AMI meter readings, and transformer metadata. This central module communicates with the “Group Charge Optimization Algorithm”, which is configured to deduce optimal charging strategies for grouped EVs. The system also interacts with Utility/ISO modules, extracting data that influences EV charging profiles and grid constraints. There is a symbiotic relationship between grid constraints and EV charging patterns. The system continuously evaluates grid limitations and juxtaposes this with the EV's charging needs. This ensures an equilibrium where EVs are efficiently charged without overloading the grid infrastructure.

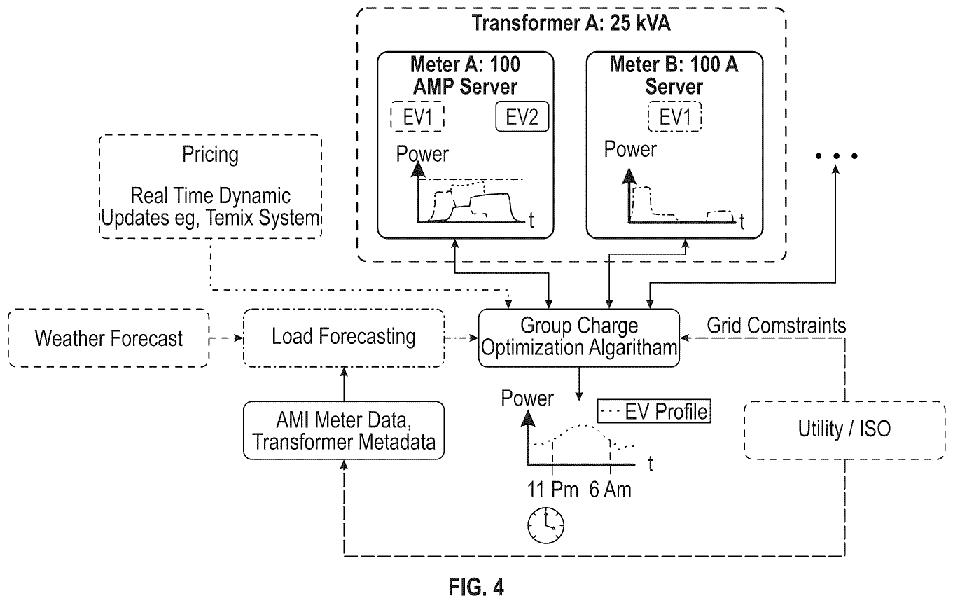

FIG. 5 is a flowchart of the present disclosure that pertains to a method of EV power management. The method includes a step 502 determining one or more conditions necessary to compute a rule set. For an effective EV charging management system, it's essential to analyze several conditions. These may encompass past charging history, time-of-day tariffs, the current demands on the charging grid, and potential future charging sessions. By evaluating these conditions, a precise set of rules is established to guide the system's EV charging behavior.

The method includes a step 504 of determining a current state of one or more devices. Every electric vehicle (EV) and its associated charging unit has a distinct consumption and charging profile. The system assesses each connected charger, identifying its present status. Is it actively charging? If so, at what rate and how much charge does the connected EV currently have? Understanding these immediate states is vital for making informed real-time charging decisions.

The method then includes a step 506 of receiving user inputs and overrides, if any, via the one or more devices. While an automated system excels at managing energy, human intervention can sometimes be essential. For example, an EV owner might be expecting a long drive soon and require a faster charge. Through an intuitive user interface, drivers can set their charging preferences, prioritize rapid charging, or even override the system's suggestions. Such user inputs are then integrated into the decision-making matrix.

Next, the method includes a step 508 of determining both a forecasted demand and a demand threshold, based on the rule set, the current state of each of the one or more devices, and the user inputs and overrides. Using the rule set, the current state of chargers, and any user inputs, the system forecasts upcoming charging demands. This projection might consider the anticipated consumption of each EV during its next drive or the energy needed to charge multiple vehicles overnight. Concurrently, a demand threshold is defined, representing the ideal maximum energy consumption to ensure cost efficiency and grid stability.

In some embodiments, when the forecasted demand is greater than the demand threshold, the method includes a step 510 of generating a plan to power off the one or more networked devices, one by one, in an order from the least important device to the most important device, until the forecasted demand no longer exceeds the demand threshold. If the predicted demand overshadows the set threshold, the system formulates an EV charging management strategy. Charging stations are sorted by their significance, possibly based on the urgency of the charging need or user preference. The system then suggests sequentially pausing or slowing down chargers until the combined demand aligns with the set limits.

The method also includes a step 512 of delivering energy-related device commands for the one or more devices, based on the generated plan. with each connected EV charger, relaying specific commands. This could mean reducing the charging speed for a particular vehicle or temporarily halting the charging process. These directives, always targeting a balance between energy consumption, user requirements, and grid stability, aim to foster an optimized EV charging landscape.

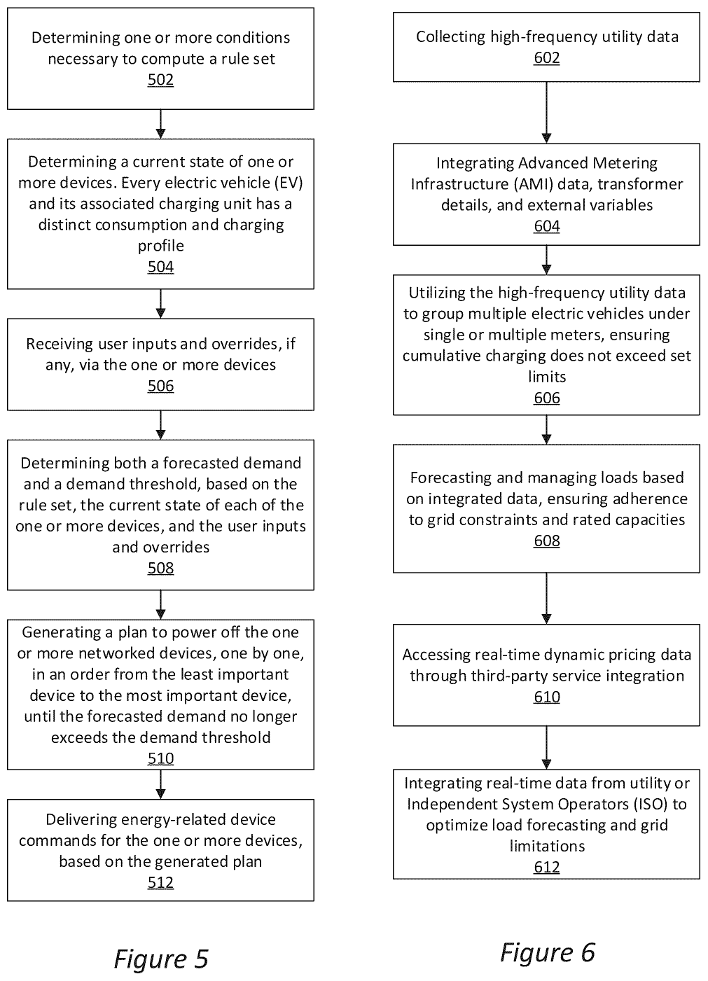

FIG. 6 is a flowchart of the present disclosure that pertains to a method of power management for EV fleets. The method can include as step 602 of collecting high-frequency utility data. In today's increasingly connected world, EV charging systems require a robust dataset to function efficiently. By collecting high-frequency utility data, these systems can continuously monitor the energy consumption rates and patterns. Such granular data provides a foundation upon which all other operations and optimizations in the EV charging ecosystem are built.

The method can include step 604 of integrating Advanced Metering Infrastructure (AMI) data, transformer details, and external variables. To make the most out of the high-frequency data, integrating Advanced Metering Infrastructure (AMI) data is pivotal. Alongside AMI, adding transformer details and other external variables ensures a comprehensive understanding of the energy landscape. These details, when combined, enable a holistic view of the infrastructure supporting EV charging, laying the groundwork for smarter, more efficient charging decisions.

The method can include step 606 of utilizing the high-frequency utility data to group multiple electric vehicles under single or multiple meters, ensuring cumulative charging does not exceed set limits. Using the acquired high-frequency utility data, EV management systems can intelligently group multiple electric vehicles under single or multiple meters. This strategic grouping ensures that the combined charging activities of these vehicles do not surpass set limits. Such grouping tactics are crucial in places with multiple EVs, like communal parking lots or residential complexes, ensuring system stability and preventing overloads.

The method can include step 608 of forecasting and managing loads based on integrated data, ensuring adherence to grid constraints and rated capacities. With an integrated dataset, it's possible to make accurate forecasts about how much energy will be required and when. This forecasting ability allows the system to predict peak charging times, balance loads, and avoid grid constraints and potential overloads. By actively managing these loads, EV charging stations can optimize their operations, ensuring that every vehicle gets the juice it needs without straining the grid.

The method can include step 610 of accessing real-time dynamic pricing data through third-party service integration. The world of energy is no longer static. Prices can fluctuate based on various factors, from demand to supply issues. By integrating real-time dynamic pricing data sourced from third-party providers, EV charging systems can adapt to these price changes instantaneously. This allows for more cost-effective charging strategies, benefiting both the operator and the vehicle owner.

The method can include step 612 of integrating real-time data from a utility or Independent System Operators (ISO) to optimize load forecasting and grid limitations. The broader energy ecosystem is vast, with multiple stakeholders involved. To further optimize load forecasting and understand grid limitations, it's essential to integrate real-time data from utilities or Independent System Operators (ISO). Such integration provides a deeper insight into the broader energy landscape, allowing EV charging systems to adapt and operate in harmony with larger grid operations.

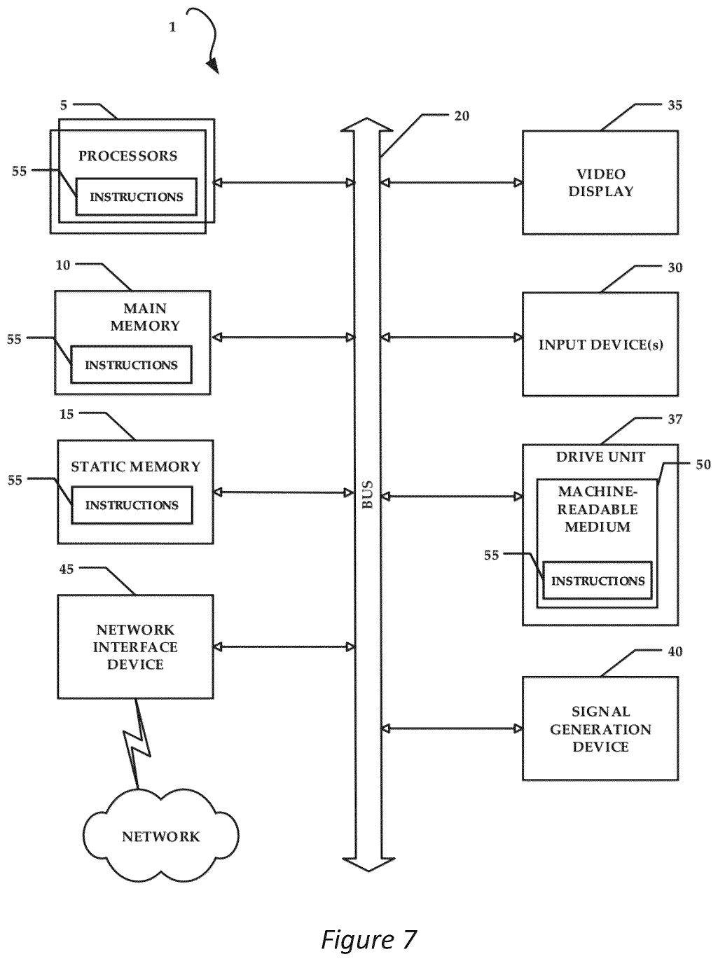

FIG. 7 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

In some embodiments, the computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer system 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A method for providing active demand management, comprising:
determining one or more conditions necessary to compute a rule set;
determining a current state of one or more devices;
receiving user inputs and overrides, if any, via the one or more devices;
determining both a forecasted demand and a demand threshold, based on the rule set, the current state of each of the one or more devices, and the user inputs and overrides;
when the forecasted demand is greater than the demand threshold, generating a plan to power off the one or more networked devices, one by one, in an order from the least important device to the most important device, until the forecasted demand no longer exceeds the demand threshold; and
delivering energy-related device commands for the one or more devices, based on the generated plan.

2. The method of claim 1, wherein the one or more devices includes one or more electrical vehicles.

3. The method of claim 2, further comprising calculating the energy delivered to the one or more electrical vehicles.

4. The method of claim 3, wherein the rule set is based on historical energy usage data, time-of-use tariffs, or grid demand patterns.

5. The method of claim 4, wherein the user inputs and overrides comprise preferred device operational hours or specific times when a device must remain operational.

6. The method of claim 5, wherein the energy delivered to the one or more electrical vehicles is prioritized based on user-defined vehicle usage schedules or a battery state of charge.

7. The method of claim 1, wherein the demand threshold is adjustable and can be set either manually by a user or automatically based on historical grid demand data.

8. The method of claim 7, wherein determining an operational status of a device includes checking if the device is in standby, active, or sleep mode.

9. The method of claim 1, wherein a calculation of energy delivered considers both efficiency of an electrical vehicle's charging system and the state of a vehicle's battery.

10. The method of claim 1, wherein the generated plan to power off devices also considers potential energy-saving modes for devices before completely turning them off.

11. The method of claim 1, further comprising sending notifications to users about potential device power-offs and giving an option for manual overrides.

12. A method for enhanced EV energy management, comprising:
collecting high-frequency home energy monitoring system data;
integrating Advanced Metering Infrastructure (AMI) data, transformer details, and external variables;
utilizing the high-frequency home energy monitoring system data to group multiple electric vehicles under single or multiple meters, ensuring cumulative charging does not exceed set limits;
forecasting and managing loads based on integrated data, ensuring adherence to grid constraints and rated capacities;
accessing real-time dynamic pricing data through third-party service integration; and
integrating real-time data from utility or Independent System Operators (ISO) to optimize load forecasting and grid limitations.

13. The method of claim 12, further comprising correlating energy consumption patterns of electric vehicles over time to create distinct charging profiles for each of the electric vehicles.

14. The method of claim 12, wherein the integration of data includes a specific module for weather forecasts that synergizes with the load forecasting mechanism.

15. The method of claim 12, further comprising sourcing dynamic pricing updates that include real-time nature of the pricing data.

16. The method of claim 12, further comprising consolidating data from weather predictions, AMI meter readings, and transformer metadata to deduce optimal charging strategies for grouped electric vehicles.

17. The method of claim 12, further comprising continuously evaluating grid limitations and juxtaposing the grid limitations with the electric vehicles charging needs to maintain grid stability.

18. A system for providing active demand management, comprising:
a processor; and
a memory coupled to the processor, the memory for storing instructions executable by the processor to perform a method comprising:
determining one or more conditions necessary to compute a rule set;
determining a current state of one or more devices;
receiving user inputs and overrides, if any, via the one or more devices;
when one or more devices comprise one or more electrical vehicles (EVs), calculating energy delivered to the one or more EVs;
determining both a forecasted demand and a demand threshold, based on the rule set, the current state of each of the one or more devices, the user inputs and overrides, and the energy already delivered to the one or more EVs,
when the forecasted demand is greater than the demand threshold, generating a plan to power off the one or more networked devices one by one, in an order from least important device to most important device, until the forecasted demand no longer exceeds the demand threshold; and
delivering energy-related device commands for the one or more devices, based on the generated plan.
